(19) United States
(12) Patent Application Publication
(10) Pub. No.: US 2003/0131362 A1
(43) Pub. Date: Jul. 10, 2003

(54) Method and apparatus for multimodal story segmentation for linking multimedia content

(75) Inventors: Radu S. Jasinschi, Ossining, NY (US); Nevenka Dimitrova, Yorktown Heights, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/042,891

(22) Filed: Jan. 9, 2002

(51) Int. Cl. H04N 7/173

(52) U.S. Cl. 725/134; 725/142; 725/87

(57) ABSTRACT

Stories are detected in multimedia data composed of concurrent streams for different modes such as audio, video and text and linked to related stories. First, time periods of uniformity in attributes of the streams serve as “building blocks” that are consolidated according to rules that are characteristic of the story to be detected. The attributes are then ranked by their respective reliabilities for detecting the story to be detected. An inter-attribute union of the time periods is cumulated attribute-to-attribute in an order that is based on the ranking. A buffered portion of the multimedia data that is delimited by the starting and ending times is retained in mass storage. The starting and ending times are indexed by characteristics of content of the portion to form a story segment which is maintained in a data structure with links to related story segments.

### BACKGROUND OF THE INVENTION

1. Field of the Invention

The present invention relates generally to segmentation of multimedia data streams, and more particularly to techniques for segmenting multimedia data streams by content.

2. Description of the Related Art

Personal video recorders (PVRs) can be programmed to selectively record multimedia related to topics or stories chosen by the user. As used hereinafter, a “story” is a thematic collection of data. Examples of a story are a news story, a sub-plot in a movie or television program and footage of a particular sports technique. The PVR may be programmed to search live broadcasts or recorded material for stories that are related to a particular topic, subject or theme. Thus, for example, the theme may be oil drilling in Alaska, and two stories within that theme are the economics of oil drilling in Alaska and the political implications of oil drilling in Alaska. A user wishing to view material on oil drilling in Alaska is presented by the PVR with the choice of playing back both or either one of these stories.

The multimedia typically is formatted into multiple modalities, such as audio, video and text (or “auditory”, “visual” and “textual”). For example, a broadcast or a recording of television program is generally formatted into at least an audio stream and a video stream and, often, into a text stream, e.g., close-captioned stream, as well.

Detecting the starting and ending points of a story is not a straightforward process. The content of a particular story may or may not exist integrally, because, for example, the story may be interrupted in the presentation by commercials or by intervening topics. Moreover, at any given temporal point, one or more of the modalities may not exist. Close-captioned text, for instance, may not be present, or if present, not understandable because, in the case of live shows, for example, the close caption results from real time transcription of these events. Artifacts appear in the close caption if the transcribing fails to keep pace with the live broadcast. In fact, audio may not be present at all, such as in a nature show with video, but without narration, for a portion of segment. Yet, that segment may show, for example, the feeding habits of bears, and may be missed by a PVR searching for material related to bears or related to the feeding habits of animals. An additional consideration in detecting a story is that one or more of the modalities may be more reliable than the others for detecting a particular story based on characteristics of the story.

Prior art approaches to story detection rely on techniques that are geared toward merely the text or audio modalities, or, alternatively, toward the modalities that are available in the multimedia. Story segmentation is discussed in: Dimitrova, N, Multimedia Computer System With Story Segmentation Capability And Operating Program Therefor, EP 0 966 717 A2 and EP 1 057 129 A1. Content based recording and selection of multimedia information is described in “Method and Apparatus for Audio/Data/Visual Information Selection”, U.S. patent application Ser. No. 09/442,960.

U.S. Pat. No. 6,253,507 to Ahmad et. al. (“Ahmad”), the disclosure of which is incorporated by reference herein, relies on text, if it is available, as the main factor in determining story boundaries. However, sometimes other modalities are more reliable in providing clues usable to detect specific stories. In deciding on which modalities dominate in story detection, or on the priorities they are accorded, the characteristics of the story to be detected are preferably taken into consideration.

### SUMMARY OF THE INVENTION

The present invention is directed to a device, and corresponding methods and programs, for identifying predefined stories (thematic data collections) of interest in multimedia data. The multimedia data typically includes a stream of audio, video or text elements, or a combination of those types of elements, as, for example, in a close-captioned television broadcast. The identified stories are indexed in a data structure and recorded in a database for future retrieval and viewing by the user. The user may, for instance, operate a menu screen on a display device to select types of stories that are of interest, such as news segments on South America, baseball games, sub-plots in a particular television serial that take place in a known setting. The user can set the invention to record the selected stories and return at a later time to search the data structure for stories that have been saved and are available for viewing. Advantageously, stories can be detected on the basis of merely one of audio, video or text components of a multimedia stream. Thus, for example, if, during a documentary, the narrator is silent over a time period, a story can nevertheless be detected based on the video recorded if the video content includes recognizable features associated with the story of interest. Moreover, the invention uses known characteristics of the story of interest to determine the priorities to be accorded to the audio, video and text in making an identification of the story in the multimedia data. As a result, the invention is more effective than prior art techniques for detecting stories. The invention, moreover, segments stories efficiently, using low-overhead techniques based on intersections and/or unions of time intervals.

The inventive methodology includes a preparatory phase for forming “temporal rules” to detect a story of interest and an operational phase for detecting a story of interest by applying the temporal rules to the multimedia data from which the story is to be detected.

In the preparatory phase, the temporal rules are typically derived by 1) identifying, for each of audio, video and text data types (or “modalities”) and, specifically, for each “attribute” of each modality (e.g., “color” being an attribute of video), time periods of uniformity in multimedia data that is known to contain the story of interest and 2) deriving temporal rules based on the time periods of uniformity.

The operational phase generally entails 1) identifying, for each attribute of each modality, time periods of uniformity in the multimedia data from which the story is to be detected, 2) for each attribute, consolidating, “intra-attribute”, pairs of time periods of uniformity according to the “temporal rules”, and 3) merging, across attributes (inter-attribute), consolidated and unconsolidated time periods of uniformity subject to a stopping criterion to thereby determine a time period during which the multimedia data contains the story of interest.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, in which like reference numerals identify similar or identical elements throughout the several views:

FIG. 1 is a block diagram of an embodiment in accordance with the present invention;

FIG. 2 is a functional diagram of forming time periods of uniformity and consolidating the periods in accordance with the present invention;

FIG. 3 is a functional diagram of merging time periods across attributes in accordance with the present invention; and

FIG. 4 is another functional diagram of merging time periods across attributes in accordance with the present invention.

### DETAILED DESCRIPTION OF THE PRESENTLY PREFERRED EMBODIMENTS

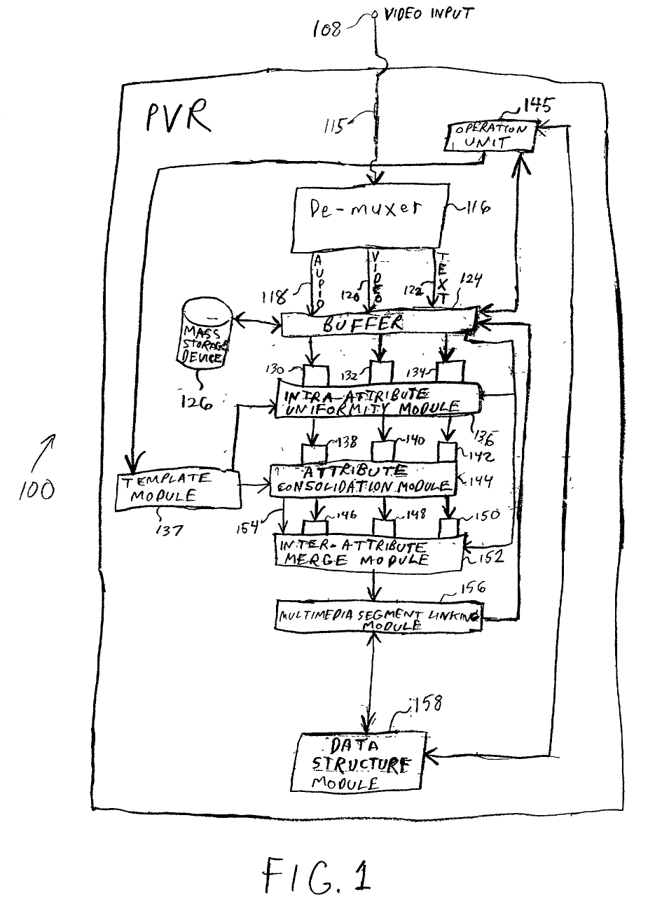

FIG. 1 depicts an exemplary personal video recorder (PVR) 100 in accordance with the present invention. The PVR 100 has a video input 108 by which multimedia data 115 is passed to a de-muxer 116. The multimedia data 115 can originate from a variety of sources, e.g., satellite, terrestrial, broadcast, cable provider, and internet video streaming. The data 115 can be encoded in a variety of compression formats such as MPEG-1, MPEG-2, MPEG-4. Alternatively, the data 115 can be received in the video input 108 as uncompressed video.

The multimedia data 115 is passed to a de-muxer 116 that demultiplexes the multimedia data 115 by modality into an audio stream 118, a video stream 120 and a text stream 122. Typically, each of the streams 118, 120 and 122 are divided into frames and time-stamped. The text stream 122 may, for example, include a close-captioned transcript and be divided so that each significant frame (also called “keyframe” or “representative frame”) contains, for instance, one or more letters of word. Keyframes are discussed further in the publication by N. Dimitrova, T. McGee, H. Elenbaas, entitled “Video Keyframe Extraction and Filtering: A Keyframe is Not a Keyframe to Everyone”, Proc. ACM Conf. on Knowledge and Information Management, pp. 113-120, 1997, the entire disclosure of which is incorporated herein by reference.

Each of the streams is comprised of elements or “temporal portions” that have attributes. The video stream 120, for example, has attributes such as color, motion, texture, and shape, and the audio stream 118 has attributes such as silence, noise, speech, music, etc.

The streams 118, 120, 122 are stored in respective sections of a buffer 124 that is in communication with a mass storage device 126, such as hard disk. The management of mass storage and optimizing for retrieval is discussed in: Elenbaas, J H; Dimitrova, N, Apparatus And Method for Optimizing Keyframe And Blob Retrieval And Storage, U.S. Pat. No. 6,119,123, Sep. 12, 2000, also issued as EP 0 976 071 A1, Feb. 02, 2000.

The streams 118, 120, 122 are also received from the respective sections of the buffer 124 via an audio port 130, a video port 132 and a text port 134 of an intra-attribute uniformity module 136. The user operates a keyboard, mouse, etc. of an operation unit 145 to select from a menu or otherwise indicate stories of interest. The selection is then communicated to the template module 137. The template module 137 transmits to the intra-attribute uniformity module 136 an attribute uniformity signal based on the selection. The intra-attribute uniformity module 136 uses the attribute uniformity signal to derive timing information from the streams 118, 120, 122. The intra-attribute uniformity module then sends the timing information to an audio port 138, video port 140 and a text port 142 of an attribute consolidation module 144.

The attribute consolidation module 144 receives temporal rules that the template module transmits based on the story selection from the operation unit 145 which includes components (not shown) of a conventional PVR, such as a microprocessor, user interface, etc. The attribute consolidation module 144 derives timing information based on the temporal rules and the received timing information and transmits the derived timing information to an audio port 146, a video port 148 and a text port 150 of an inter-attribute merge module 152. Based on parameters of the derived timing information, the attribute consolidation module 144 selects a “dominant” attribute, i.e. an attribute that predominates in the subsequent story detection, and transmits the selection over a line 154 to the inter-attribute merge module 152.

The inter-attribute merge module 152 uses the dominant attribute selection and the derived timing information received via the ports 146, 148, 150 to derive further timing information. The inter-attribute merge module 152 receives the streams 118, 120, 122 from the respective sections of the buffer 124 and derives characteristics of content of the streams 118, 120, 122 delimited by the derived timing information. The inter-attribute merge module 152 may instead, or in addition, obtain from the intra-attribute uniformity module 136 characteristics of content that the module 136 has already derived. The inter-attribute merge module 152 then creates a “story segment” by indexing the derived timing information by the characteristics of the content. The merging techniques will be explained in more detail below. Alternatively, the attribute consolidation module 144 and the inter-attribute merge module 152 may be implemented as a single segment identifying module. The inter-attribute merge module 152 transmits the story segment to a multimedia segment linking module 156.

The multimedia segment linking module 156 incorporates the story segment into a data structure of the data structure module 158 and links the story segment to related story segments within the data structure, if any related story segments exist in the data structure. The multimedia segment linking module 156 also sends timing information of the created story segment to the buffer 124. The buffer 124 then uses the timing information to identify story segments in its buffered audio stream 118, video stream 120 and text stream 122 and stores the identified story segments into the mass storage device 126. The PVR 100 thereby accumulates stories that are semantically related to a topic the user has selected via the operation unit 145.

When the user operates the operation unit 145 to request retrieval of a story for presentation (or “viewing”), the operation unit 145 communicates with the data structure module 158 to retrieve timing information that is indexed by a story segment or by a group of related story segments. The operation unit 145 communicates the retrieved timing information to the buffer 124. The buffer 124 uses the timing information to retrieve the story segment or group of related segments from the mass storage device 126 and forwards the segment or segments to the operation unit 145 for subsequent presentation to the user via a display screen, audio speakers and/or any other means.

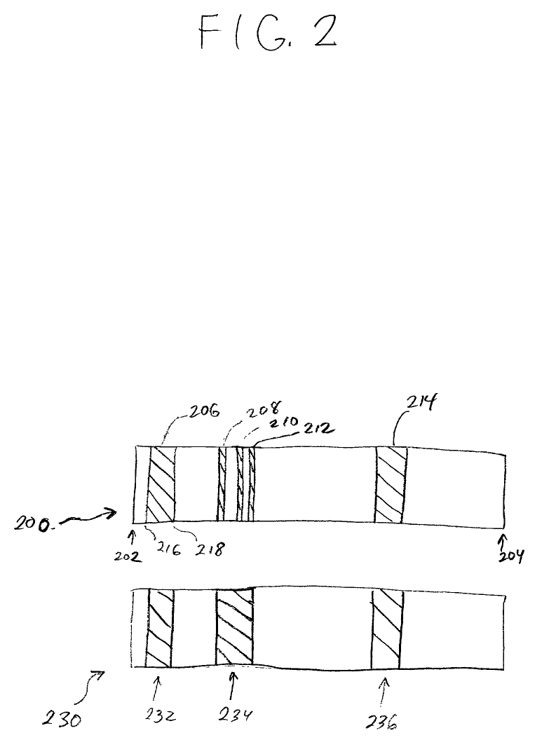

FIG. 2 shows an example of a functional diagram of two temporal representations of an attribute of a modality stream, e.g., audio stream 118, video stream 120 or text stream 122 of the respective audio, video and text modalities of the multimedia data 115. A representation 200 is created by the intra-attribute uniformity module 136 and extends from time 202 to time 204 in accordance with the temporal order within a modality stream that is governed by the time stamps in the modality stream.

An exemplary set of attributes for audio is silence, noise, speech, music, speech plus noise, speech plus speech and speech plus music. Other audio attributes are pitch and timber. For video, the set may include, for example, color, motion (2-D and 3-D), shape (2-D and 3-D) and texture (stochastic and structural). For text, the set may include keywords i.e. selected words, sentences and paragraphs. Each attribute assumes a specific numerical value at any given time. For example, the value for the noise attribute may be an audio measurement that indicates noise if the measurement exceeds a threshold. The value of the color attribute may be, for instance, a measure of the luminance, or brightness value, of a frame. The value can consist of multiple numbers. For instance, the color attribute value may consist of the bin counts of a luminance histogram for a single frame. A histogram is a statistical summary of observed occurrences and consists of a number of bins and counts for each bin. Thus, for luminance levels 1 through n, a luminance histogram has a bin for each luminance level and a count for each bin that represents the number of occurrences of that luminance level as the frame is examined, for example, pixel by pixel. If there are “x” pixels in the frame with luminance level “j”, the bin for value “j” will have a count of “x”. The bin count can alternatively represent a range of values, so that “x” indicates the number of pixels within a range of luminance values. The luminance histogram may be part of a histogram that further includes bins for hue and/or saturation, so that a color attribute value may be, for example, the bin count for a hue or saturation level. The shape and texture attributes may be defined, respectively, with values that correspond to a degree of match between a portion of a frame and respective shapes or textures for which, for example, a frame will be examined, although a value need not be defined on a single frame. The text attributes of keywords, sentences and paragraphs, for example, may each be defined for multiple frames. Thus, for example, a keyword attribute may be defined for a particular word, or, more typically, a particular root of a word. Thus, the number of occurrences of the word “yard”, “yards”, “yardage”, etc. can be counted over a predetermined number of consecutive frames, or a running count can be maintained according to a particular stopping criterion.

The representation 200 pertains to the text attribute for the keyword “yard” including its various suffixes. It has been observed that announcers of golf matches or tournaments will often use the word “yard”, or variations from that stem, when a golfer makes a drive, i.e., a long distance shot. The “story” to be detected, i.e., story of interest, is footage of a golf drive.

The representation 200 has time periods of “uniformity” or “homogeneity” 206, 208, 210, 212, 214, during which a value of an attribute of a modality meets an attribute uniformity criterion. In the current example, the attribute uniformity criterion specifies that the number of occurrences of a word having as its root the word “yard” divided by the length of the time period examined is greater than a predetermined threshold. The period of uniformity 206 has a beginning time 216 and a terminating time 218. The frame at beginning time 216 contains, for example, the letter “y” and subsequent frames within the period 206 reveal that the “y” is the first letter of a “yard” keyword. The terminating time 218 is determined as the time at which the ratio of keyword occurrences to time period length no longer exceeds the threshold. The periods 208 through 214 are determined in similar manner, and, in the current embodiment, using the same threshold.

Preferably, the attribute uniformity signal that the intra-attribute uniformity module 136 receives from the template module 137 specifies the modality, attribute, numerical value and threshold. In the above example, the modality is text, the attribute is “keyword” and the numerical value is the number of words having “yard” as the stem.

Although a representation of a keyword attribute is shown, other attributes of the text modality or of other modalities may be processed instead or additionally to produce respective representations. For example, a representation of a color attribute that is valued according to the above-mentioned luminance histogram may be defined by an attribute uniformity criterion that examines luminance histograms of each consecutive frame and continues to include each examined frame in the period of uniformity until a measure of distance between respective values of two consecutive histograms is greater than a predetermined threshold. Various distance measures can be used, such as L1, L2, histogram intersection, Chi-Square, bin-wise histogram intersection as described in Superhistograms for video representation, N. Dimitrova, J. Martino, L. Agnihotri, H. Elenbaas, IEEE ICIP 1999 Kobe Japan. Histogram techniques to detect uniformity are known in the literature. See, for example, Martino, J; Dimitrova, N; Elenbaas, J H; Rutgers, J, A Histogram Method For Characterizing Video Content, EP 1 038 269 A1.

Alternatively, the PVR 100 may be implemented without an attribute uniformity signal and with the intra-attribute uniformity module 136 searching for periods of uniformity for a predetermined set of attributes and respective numerical values and thresholds independent of the story to be detected. In one technique, each representative frame of the multimedia stream 115 has a numerical value for each attribute in the predetermined set. The values are monitored as the video is temporally traversed, and a period of uniformity exists as long as the difference between values of consecutive frames stays within a predetermined range. When a period of uniformity terminates, a new period of uniformity begins, although periods of uniformity having a duration below a given limit are eliminated. In another technique, the value of the frame is compared not to the previous frame, but to an average of values of frames already included in the period of uniformity. Similarly, a minimum duration is required to retain a period of uniformity.

Ahmad (U.S. Pat. No. 6,253,507) discusses music recognition methods, whereby a distinctive musical theme, such as one that introduces a particular broadcast television program, can used to identify a “break” in the audio. In the context of the present invention, the theme or part of the theme would be a “sub-attribute” of the music attribute. For example, the value of the theme attribute may be a measure of the similarity between the content of the audio stream 118 and the theme or theme portion to be detected. Additional techniques for identifying periods of uniformity in audio are implementable based on pause recognition, voice recognition and word recognition methods. The present inventors have investigated a total of 143 classification features for the problem of segmenting and classifying continuous audio data into seven categories. The seven audio categories used in the system include silence, single speaker speech, music, environmental noise, multiple speakers' speech, simultaneous speech and music, and speech and noise.

The present inventors have used tools for extracting six sets of acoustical features, including MFCC, LPC, delta MFCC, delta LPC, autocorrelation MFCC, and several temporal and spectral features. The definitions or algorithms adopted for these features are given in the paper by Dongge Li: D. Li, I. K. Sethi, N. Dimitrova, and T. McGee, Classification of General Audio Data for Content-Based Retrieval, Pattern Recognition Letters, vol. 22, pp. 533-544, 2001.

As in the above-mentioned case of the music attribute and a specific theme attribute, some attributes may bear a hierarchical relationship to other attributes. For example, the video attribute “color” can be used to detect periods of uniformity in which the luminance level is relatively constant. “Color”, however, can have a “sub-attribute”, such as “green” which is used to detect or identify periods of uniformity in which the visual content of the video stream 120 is green, i.e. the light frequency is sufficiently close to the frequency of green.

Another example of attribute uniformity is extracting all video segments that contain overlaid video text, such as name plates in news, title of programs, beginning and ending credits. Explanation of video text extraction is given in: MPEG-7 VideoText Description Scheme for Superimposed Text. N. Dimitrova, L. Agnihotri, C. Dorai, R Bolle, International Signal Processing and Image Communications Journal, September, 2000. Vol. 16, No. 1-2, pages 137-155 (2000).

To identified periods of uniformity, the attribute consolidation module 144 applies temporal rules from the template module 137 to consolidate pairs of identified time periods of uniformity into a single time period of uniformity or “story attribute time interval”. The temporal rules are formed before story detection is performed on the multimedia stream 115, and may be static (fixed) or dynamic (changing, as in response to new empirical data). In forming the temporal rules in the preparatory phase, periods of uniformity are identified in multiple video sequences known to contain the story to be detected. Preferably, during the preparatory phase, the periods of uniformity are formed as in the alternative embodiment for the operational phase discussed above. That is, when one period of uniformity ends, the next period of uniformity begins, subject to the minimum duration requirement. The periods of uniformity for the various video sequences are examined to detect any recurring temporal patterns, i.e. patterns characteristic of the story to be detected. The temporal rules are derived based on the detected recurring temporal patterns. Typically, there are other additional considerations in forming the temporal rules, e.g., a series of commercials that are known to run during presentation of the story to be detected and which are of known total duration may separate two periods of uniformity that have similar values. In the operational phase, consolidation based on the temporal rules amounts to recognition that the two intervals indicate (although not definitively) the story to be detected. Nevertheless, an unconsolidated period of uniformity may indicate the story to be detected. For example, on a clear day, the golf drive footage may have an uninterrupted, continuous pan of nearly pure sky blue video, resulting in a period of uniformity that is not consolidated.

For the keyword attribute in the present example, the temporal rules dictate that, in forming a story attribute time interval, two consecutive periods of uniformity (formed based on the frequency of occurrence of “yard”, as discussed above) are mutually clustered if the temporal distance between them is less than a predetermined threshold. In the present example, based on the temporal rules, periods 206 and 208 are not mutually consolidated, but periods 208, 210 and 212 are mutually consolidated, to form in a representation 230 a story attribute time interval 234 that temporally spans the periods 208, 210, 212. Similarly, based on the temporal rules, periods of uniformity 214 and 212 are not mutually consolidated. Instead, in the representation 230, a story attribute time interval 236 is formed to temporally coincide with the period of uniformity 214, and, similarly, a story attribute time interval 232 is formed to temporally coincide with period of uniformity 206.

Although the attribute consolidation module 144 has been demonstrated as consolidating periods of uniformity for the same value of an attribute, periods for different values of the same attribute may be mutually consolidated. Thus, for example, the intra-attribute uniformity module may determine respective periods of uniformity for each of two values of a keyword, e.g., the number of occurrences of “yard” and the number of occurrences of “shot”. The word “shot” has also been observed to be spoken by announcers who are announcing a golf drive, particularly in conjunction with the word “yard”. If, for example, period of uniformity 210 represents the keyword “shot” instead of the keyword “yard”, the temporal rules used by the attribute consolidation module 144 to decide whether to consolidate will be based on both values of the keyword. Accordingly, the attribute consolidation module 144 may decide to consolidate the periods 208, 210, 212 as before, to create the story attribute time interval 234.

The attribute consolidation module 144 is not confined to periods within the same attribute; instead, periods within different attributes may be consolidated into a story attribute time interval. For example, the text stream 122 is a close-captioned text embedded by the broadcaster. The closed captions text in TV news sometimes includes markers that designate story boundaries. However, even close-captioned text cannot always be relied upon in detecting stories, because the close-caption sometimes includes, instead, less reliable indicia of story boundaries such as paragraph boundaries, the beginning and end of advertisements, and changes in speaker. A change of speaker, for example, may occur within a scene of a single story, rather than indicate a transition between respective stories. Close-caption uses as delimiters characters such as “>>>” as indicia of boundaries between portions of the multimedia stream describing change of topics. Regardless of whether the close-caption delimits story boundaries or other kinds of boundaries, if the text stream 122 contains close-caption, the intra-attribute uniformity module 136 identifies periods of uniformity in the close-caption attribute during which consecutive frames contain the close-caption delimiters. The value of the close-caption attribute may be the number of consecutive close-caption marker elements detected, so that, for example, three consecutive “>” marker elements meet an attribute uniformity threshold of three marker elements and, therefore, define a period of uniformity. Preferably, portions of the text stream in between delimiters are also processed by the intra-attribute uniformity module 136 for particular keyword value(s), and periods of uniformity are also formed for the particular keyword(s). The keyword(s) could be words known, for example, to start and end the story to be detected. The template module 137 transmits, to the attribute consolidation module 144, temporal rules that are applied to the close-caption and keyword periods of uniformity in determining story attribute time intervals. Temporal rules may specify, for example, a time span between a close-caption period of uniformity and a period of uniformity for a particular keyword that must exist, based on characteristics of the story to be detected, if the framing close-caption markings are to be deemed defining of the story to be detected. For example, if the anchorperson for particular economic report typically uses known words or phrases to begin or end the report, one or more occurrences of the word or phrase can be detected as a period of uniformity. The time span between that period of uniformity and close-caption period of uniformity can be compared to a predetermined threshold to determine if framing close-caption periods define the particular economic report. Optionally, commercials can be detected an pointers delimiting commercials can be maintained in the periods of uniformity so that commercials are skipped upon viewing the stories of interest. Detecting commercials is known in the art. One introductory cue might be, for example, “we will be back after these messages.”

The attribute consolidation module 144 has the further function of applying the temporal rules to select a dominant attribute. The selection is based on a comparison between a threshold and a parameter of the periods of uniformity, and may serve to override a default choice of a dominant attribute.

If the multimedia data 115 includes a text stream 122, an attribute of the text stream 122 typically is accorded dominance initially as a default, because it has been observed that story detection is generally more dependent on text than on other modalities.

However, as discussed above, text attributes cannot always be relied on, and attributes of other modalities may be more reliable. For example, periods of uniformity for a text attribute may be formed based on a particular keyword. Returning to FIG. 2, the temporal rules focus on specific parameters of the period of uniformity, such as the beginning times and terminating times and/or the lengths of the periods. Time gaps between the terminating time of one period and the beginning time of a subsequent, consecutive period may, for example, be required to be within a predetermined threshold in order for the respective periods of uniformity to be consolidated. Besides consolidation, the temporal rules are used in assessing reliability of a story attribute time interval of a given attribute in serving as a basis for detecting the story of interest. If the number of periods consolidated into a single time period of uniformity exceeds a limit predetermined based on empirical data, this may indicate that the keyword attribute is relatively unreliable for detecting the story. Preferably, the inter-attribute merge module 152 assigns to the keyword attribute a commensurate “reliability measure”. On the other hand, a “pan” attribute of the video stream 120 may exhibit distinctive and predictable periods of uniformity that are indicative (although not determinative) of footage of a golf drive. Panning is a horizontal scanning of the camera, so that a series of frames would show, for example, footage that scans across the horizon. The periods of uniformity are defined as periods during which the pan attribute is “on”. The temporal rules for the “pan” attribute may accord, for example, more reliability to the “pan” attribute if fewer periods of uniformity of the multimedia data from which the story is to be detected are within a mutual proximity below a predefined threshold. The reasoning is that the camera continuously pans in following the flight of a golf ball that has been hit in a golf drive and that the panning is not generally followed soon by other panning. Therefore, based on the relative reliability measures ascribed to the keyword and pan attributes, the pan attribute may be deemed the dominant attribute, thereby overriding the default dominance of the keyword attribute. In the current example, “pan” is an attribute assuming a value indicative of horizontal motion. The value is compared to a threshold to determine if panning is “on” or “off” frame-by-frame and thereby determine a period of uniformity. Beside “pan” other types of camera motion are “fixed”, “tilt”, “boom”, “zoom”, “dolly” and “roll. These different types of camera motion are discussed in Jeannin, S., Jasinschi, R., She, A., Naveen, T., Mory, B., & Tabatabai, A. (2000). Motion descriptors for content-based video representation. Signal Processing: Image Communication, Vol. 16, issue 1-2, pp. 59-85.

The reliability measure that the temporal rules for a given story assign to an attribute may vary from one period of uniformity to the next and may depend on characteristics of a period of uniformity other than its parameters. Thus, for example, if a text attribute has periods of uniformity based on the keywords “economy” and “money”, the temporal rules may dictate that text is dominant over audio only during periods of uniformity based on the keyword “economy”.

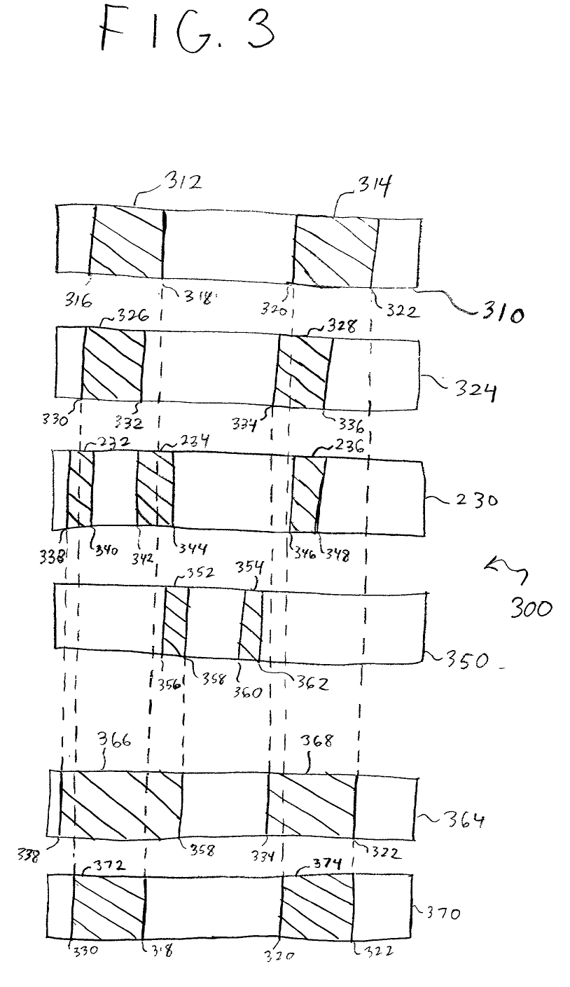

FIG. 3 is an exemplary functional diagram of an inter-attribute merge process 300 in accordance with the present invention. A representation 310 is temporally divided into story attribute time intervals 312, 314 that span respective periods of uniformity for the pan attribute, so that panning is “on” during the period of uniformity. The periods 312, 314 have respective start and end times 316, 318, 320, 322. A representation 324 is temporally divided into story attribute time intervals 326 and 328 that span respective periods of uniformity during which a color attribute of the video stream 120 has a value that indicates that the frame is predominantly sky blue. The periods 326, 328 have respective start and end times 330, 332, 334, 336. FIG. 3 also shows representation 230 from FIG. 2. The story attribute time intervals 232, 234, 236 have respective start and end times 338, 340, 342, 344, 346, 348. A representation 350 is temporally divided into story attribute time intervals 352, 354 that span respective periods of uniformity during which an “applause” attribute, a sub-attribute of the noise attribute, has a value in a given range. Applause recognition is known in the art and described, for example, in U.S. Pat. No. 6,188,831 to Ichimura. The periods of uniformity 352, 354 have respective start and end times 356, 358, 360, 362.

In the current example, the “pan” attribute has a reliability measure that exceeds that of the other attributes enough that the “pan” attribute is made dominant. Accordingly, the representation for the pan attribute is shown on top. Alternatively, the pan attribute can be predefined as dominant for particular stories such as footage of golf drives. Preferably, as in the current example, the other attribute representations are ordered based on their respective reliability measures, with the color attribute second, the keyword attribute third, etc. A higher reliability measure does not guarantee precedence in the ordering. Thus, the noise representation 350 may be required to have a reliability measure that exceeds that of the color representation 230 by a given threshold in order for the noise representation 350 to precede the color representation 230. Alternatively, the ordering may be pre-designated in the PVR 100, and, optionally, selectable by a user operating the operating unit 145.

A representation 364 temporally defines a cumulative, inter-attribute union of a story attribute time interval determined based on a dominant attribute with at least one other story attribute time interval determined based on another respective attribute. A story attribute time interval determined based on a dominant attribute is interval 312. A story attribute time interval determined based on another story attribute time interval is interval 326. A cumulative, inter-attribute union initially includes a story attribute time interval determined based on a dominant attribute, and, in the present example, initially includes interval 312. The next interval to be included within the cumulative, inter-attribute union is interval 326, because interval 326 is next in the ordering of representations and because interval 326 intersects, at least partially, with an interval already cumulated, namely interval 312. Thus, inclusion in the cumulative, inter-attribute union is conditional upon intersection, at least partially, with an interval already included within the union. For the same reasons that interval 326 is included in the cumulative, inter-attribute union, the intervals 314, 328 are also included within the cumulative, inter-attribute union. At this point in the accumulations, the start and end times of the union are defined by times 330, 318, 334, 322.

Proceeding to the next representation in the ordering, representation 230, story attribute time intervals 232, 234, 236 are included within the cumulative, inter-attribute union. The start times and end times of the union are now defined by the times 338, 344, 334, 322.

Next, in representation 350, the story attribute time interval 352 is included within the cumulative, inter-attribute union, because it temporally intersects, at least partially, with a story attribute time interval that is already included with the union, namely interval 234. The story attribute time interval 354, however, is not included within the union, because interval 354 does not intersect at all with any of the story attribute time intervals that are already included within the union. Accordingly, the start and end times of the union are now defined by the times 338, 358, 334, 322. These times are shown in representation 364, where like reference numerals have been carried down from the previous representations. According to the stopping criterion applied in this example, merging stops at this point, i.e. after merging of the representation 350. As will be seen below, other stopping criteria are possible. Representation 364 is a cumulative, inter-attribute union that defines two story segment time intervals 366, 368. The two story segment time intervals 366, 368 are deemed to delimit separate stories because they are temporally mutually exclusive. Close-captioned transcription often trails the corresponding audio and video, which are generally more mutually synchronized temporally. Therefore, before the inter-attribute merge, story attribute time intervals determined based on close-captioned attributes are optionally shifted temporally to an earlier time to compensate for delay in the close-captioned text. Techniques of aligning close-captioned text to the other modalities are discussed in U.S. Pat. No. 6,263,507 to Ahmad and in U.S. Pat. No. 6,243,676 to Witteman.

In an alternative embodiment, a story segment is included in the cumulative, inter-attribute union only if its temporal intersection with the story attribute time interval determined based on the dominant attribute is at least a predetermined ratio of the length of the story attribute time interval determined based on the dominant attribute. For a ratio of 50%, for example, interval 326 temporally intersects interval 312 by at least 50% of the length of interval 312, and thus is included within the cumulative, inter-attribute union. Similarly, interval 328 temporally intersects interval 314 by at least 50% of the length of interval 314, and is likewise included within the cumulative, inter-attribute union. Therefore, at this point in the accumulations, the union is delimited by the times 330, 318, 334, 322. None of the intervals 232, 234, 236 intersect the intervals 312, 314, respectively, by at least 50% of the lengths of the intervals 312, 314, respectively, and are, therefore, not included within the cumulative, inter-attribute union. The same holds for the intervals 352, 354, which are likewise not included within the cumulative, inter-attribute union. Accordingly, the start and end times of the union are now defined by the times 330, 318, 320, 322, and the stopping criterion stops merging at this point. These times are shown in representation 370, where like reference numerals have been carried down from the previous representations. Representation 370 is a cumulative, inter-attribute union that defines two story segment time intervals 372, 374. The two story segment time intervals 372, 374 are deemed to delimit separate stories because they are temporally mutually exclusive.

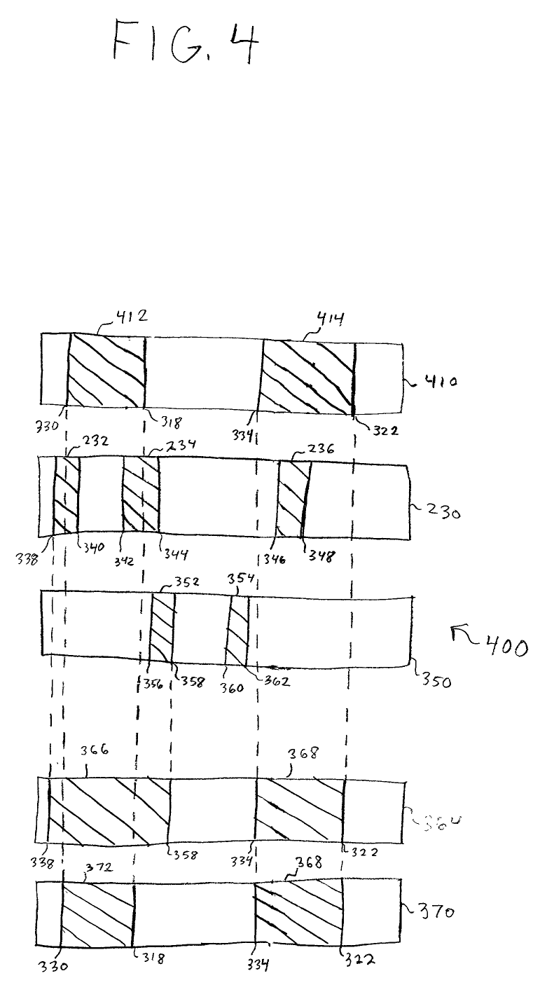

FIG. 4 is an exemplary functional diagram of an inter-attribute merge process 400 that demonstrates the option of forming a union of the story attribute time intervals of two attributes before proceeding with the merge. (This inter-attribute “union” is to be distinguished from inter-attribute “consolidation”, as shown earlier between “close-caption” and “keyword” attributes. The union of temporally exclusive time intervals, for example, is different from the “consolidation” of those time intervals, which produces a time interval that spans the two temporally exclusive time intervals.) Reference numbers are retained for those that are associated with structures already shown in FIG. 3. A representation 410 contains story attribute time intervals 412, 414 that are respective unions of the story attribute time intervals 312, 330 and of the story attribute time intervals 314, 328, respectively. The inter-attribute merge module 152 creates the unions 412 and 414 before beginning the merge process illustrated in FIG. 3. The story attribute time intervals 412, 414 are both determined based on a dominant attribute, namely “pan” (and also determined based on a non-dominant attribute, namely “color”). The representations 230 and 350 appear also in FIG. 3 and correspond to the text attribute “keyword” and the audio attribute “noise”.

In FIG. 4, the representation 364 contains two cumulative, inter-attribute unions 366, 368 of story attribute time intervals that are also shown in FIG. 3. In forming the unions 366, 368, the process proceeds by the same process performed in FIG. 3. Story attribute time intervals in the representations 410, 230, 350 that intersect at least partially with a story attribute time interval already included in the cumulative, inter-attribute union are accumulated.

It just so happens that the story segment time intervals 366, 368 in FIG. 4 (which shows the pan and color attributes as pre-joined) resulting from the “at least partial intersection method” are identical to the story segment time intervals 366, 368 formed by the same method in FIG. 3 (pan and color attributes separate).

Similarly, using the “intersection by at least a predetermined ratio method” to merge the representations just happens to produce a story segment time interval 372 in FIG. 4 (pan and color attributes pre-joined) which is identical to the same interval produced by the merge process in FIG. 3 (pan and color attributes separate).

However, the “intersection by at least a predetermined ratio method” yields a different result by producing the story segment time interval 368 in FIG. 4 (pan and color attribute pre-joined) whereas the method produces a story segment time interval 374 in FIG. 3 (pan and color attribute separate). The difference in the respective results is due to the interval 328 temporally intersecting the interval 314 so that they are pre-joined in FIG. 4, whereas the interval 328 is excluded from the cumulative, inter-attribute union in FIG. 3 for failing to intersect the interval 314 by 50% of the length of the interval 314.

A variation of the “at least partial intersection method” involves making multiple passes through the representations, rather than making a single pass, the passes being made back and forth. That is, a downward pass is made in the above-demonstrated way, and is followed by an upward pass that includes in the cumulative, inter-attribute union any additional story attribute time intervals that, now in the upward pass, intersect, at least partially, with a story attribute time interval that has already been cumulated. For example, dominance can be assigned in the order text, audio and video for the first pass, so that merging occurs in a downward order corresponding to text, then audio and then video. A second pass of the merging occurs in the opposite order, corresponding to video, then audio and then text. Thus, odd-numbered passes merge in the same order as does the first pass, whereas even-numbered passes merge in the same order as does the second pass. The number of passes is determined by the stopping criterion.

Optionally, the dominance of attributes, and a corresponding order in which they are merged, may change from pass to pass. Thus, in the example cited in the paragraph above, for example, the second pass may merge in the order audio, then text, then video. The dominance assigned to attributes in the second pass, or a subsequent pass, is predetermined empirically according to the genre (category) of the video program (e.g. news, action, drama talk show, etc). The genre can be determined, for example, by the intra-attribute uniformity module 136, using automatic video classification methods know in the art. The empirical learning process determines how to vary assignment of dominance to the attributes by pass so as to achieve desired story segmentation results.

Another variation of the “at least partial intersection method” includes story attribute time intervals selectively, based on the reliability measure of attributes from which they are determined.

As a further alternative, the story segment time interval can be made identical to a story attribute time interval determined based on a dominant attribute.

Operationally, a user specifies through the operation unit 145 stories to be extracted from the multimedia data 115 for retention. The story selections are forwarded to the template module 137. The incoming multimedia data 115 is demultiplexed by the de-muxer 116 and buffered in sections of the buffer 124 that correspond to the modality of the respective modality stream component of the incoming multimedia data 115.

The intra-attribute uniformity module 136 receives the modality streams 118, 120, 122 via respective ports 130, 132, 134 and an attribute uniformity signal from the template module 137 that specifies attributes for which periods of uniformity are to be identified. The intra-attribute uniformity module 136 sends the beginning and terminating times of the periods to the attribute consolidation module 144 via the respective modality ports 138, 140, 142.

The attribute consolidation module 144 receives temporal rules characteristic of the story to be detected from the template module 137 and applies the rules to the periods of uniformity to form respective story attribute time intervals. Application of the rules also allows the attribute consolidation module 144 to derive reliability measures for respective attributes and, based on the measures, to override default selections, if any, of the dominant attribute. The attribute consolidation module 144 conveys the choice of a dominant attribute to the inter-attribute merge module 152 and transmits the start and end times of the story attribute time intervals to the inter-attribute merge module 152 via the ports 146, 148, 150 of the respective modalities.

The inter-attribute merge module 152 merges the story attribute time intervals of the various attributes cumulatively, beginning with the dominant attribute which the attribute consolidation module 144 has identified and in accordance with an ordering based on the respective attribute reliability measures that the inter-attribute merge module derives. The result of the merge is one or more story segment time intervals.

Once a story segment time interval is determined, the inter-attribute merge module 152 forms a story segment by indexing the start time and the end time of the interval by characteristics of content of a portion of the multimedia data that resides temporally within the story segment time interval. An example of the characteristics of content is histogram or other data used in identifying periods of uniformity that the intra-attribute merge module 152 obtains from the intra-attribute uniformity module 136. Another example is a word or words descriptive of the story (or of the theme of the story, such as “global economics”) that the inter-attribute merge module 152 derives from close-captioned text, possibly after consulting a lexical or “knowledge” database. A further example is characteristic data that the inter-attribute merge module 152 derives directly from the streams 118, 120, 122 in the buffer 124.

The intra-attribute merge module 152 forwards the indexed segment to the multimedia segment linking module 156. The multimedia linking module 156 signals the buffer 124 to store a portion of the currently buffered streams 118, 120, 122 that is temporally within the start time and end time of the new story segment into the mass storage device 126. The buffer 124 maintains information that links the start and end time indices of the new story segment to the mass storage address where the portion is stored.

Alternatively, the start and end times of story attribute segments included within the cumulative, inter-attribute union are combined intra-modally, e.g., by retaining the earliest start time and the latest end time of any story attribute time interval of a given mode. The modal start times are then maintained as pointers in the story segment, and only the portions of the streams 118, 120, 122 that temporally reside within the respective pointers are saved to mass storage. The multimedia segment linking module 156 stores the new story segment in the data structure and coordinates with the data structure module 158 in determining if any related stories already exist in the data structure, i.e., if the new story segment and any pre-existing story segment together meet a segment relatedness criterion such as one employed in relevance feedback. Story linking is described in “Method and Apparatus for Linking a Video Segment to Another Segment or Information Source,” Nevenka Dimitrova, EP 1 110 156 A1. The new story segment and any related story segments are linked within the data structure.

To view a particular story, the user operates the operation unit 145, as through a screen menu, to transmit search indices to the data structure module 158. The data structure module 158 responds to the operation unit 145 with corresponding start and end times of the story desired and of related stories, if any. The operation unit 145 forwards that start and end times to the buffer 124, which references them against the maintained links to determine the addresses that delimit the story or stories in the mass storage device 126. The buffer forwards the story or stories from the mass storage device 126 to the operation unit 145 for viewing by the user.

The present invention is not limited to implementation within PVRs, but has applications, for example, in automatic news personalization systems on the Internet, set-top boxes, intelligent PDA's, large video databases and pervasive communication/entertainment devices.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus for identifying segments of multimedia data of interest, the multimedia data comprising a stream of at least one of audio, video and text elements, the elements having at least one attribute with a numerical value, the attribute being indicative of the content of the element, the apparatus comprising:
an intra-attribute uniformity module for identifying a time period of uniformity, if any, during which the numerical value of the attribute of the element of the respective stream meets an attribute uniformity threshold; and
a module for identifying a segment of the multimedia data corresponding to the identified time period of uniformity.

2. The apparatus of claim 1, wherein the segment identifying module comprises an attribute consolidation module for consolidating pairs of identified time periods of uniformity into a single time period of uniformity that temporally comprises the pair of identified time periods of uniformity.

3. The apparatus of claim 2, wherein the consolidating of a pair is based on a comparison between a time span intervening between the pair and a threshold that is based on the attribute and on a characteristic of a predefined thematic collection of data.

4. The apparatus of claim 2, wherein the attribute consolidation module identifies a dominant attribute based on a comparison between a threshold and a parameter of a time period of uniformity identified by the intra-attribute uniformity module.

5. The apparatus of claim 4, wherein the segment identifying module further includes an inter-attribute merge module for forming a cumulative, inter-attribute, union of identified and single periods, if any, determined based on a dominant attribute with identified and single periods, if any, determined based on at least one other respective attribute, the union defining a story segment time interval having a start time and an end time, at least some cumulations in forming the union being conditional upon the existence of an intersection, at least partial, between an identified or single period being accumulated and an identified or single period already accumulated in forming the union.

6. The apparatus of claim 5, wherein the inter-attribute merge module indexes the start time and end time of the story segment time interval by characteristics of content of a portion of the multimedia data that is temporally within the story segment time interval.

7. The apparatus of claim 6, further comprising a multimedia segment linking module for establishing a link among ones of indexed story segment time intervals that meet a segment relatedness criterion.

8. The apparatus of claim 5, wherein said at least one other respective attribute comprises at least two attributes, an ordering of attributes by which said cumulative, inter-attribute union is formed being determined based on comparisons between thresholds and respective parameters of a time period of uniformity identified by the intra-attribute uniformity module.

9. The apparatus of claim 8, wherein the accumulations continue for multiple passes over the attributes.

10. The apparatus of claim 9, wherein the multimedia data has a genre, and the ordering changes based on the genre of the multimedia data on a second pass and subsequent passes, if any.

11. The apparatus of claim 5, wherein said cumulative, inter-attribute union includes identified and single periods that temporally intersect an identified or single period determined based on a dominant attribute by at least a predetermined ratio of a length of the respective identified or single period determined based on the dominant attribute.

12. The apparatus of claim 5, wherein said inter-attribute merge module is configured to form an interim union of an identified or single period determined based on a first attribute with an identified or single period determined based on a second attribute, the interim union defining a period that is accumulated in forming the cumulative, inter-attribute union.

13. The apparatus of claim 5, said at least one other respective attribute comprising at least two attributes, an ordering of attributes by which said cumulative, inter-attribute union is formed being subject to revision as said stream of elements is processed by said apparatus to identify one of said segments of multimedia data of interest.

14. The apparatus of claim 4, wherein the segment identifying module further includes an inter-attribute merge module for forming a story segment time interval that temporally defines a story segment comprising content characteristic of a portion of the stream that is located within an identified or single period determined based on a dominant attribute.

15. The apparatus of claim 2, wherein the segment identifying module further includes an inter-attribute merge module for forming a cumulative, inter-attribute, union of identified and single periods, if any, determined based on a pre-defined, dominant attribute with identified and single periods, if any, determined based on at least one other respective attribute, the union defining a story segment time interval having a start time and an end time.

16. The apparatus of claim 2, wherein the attributes have characteristics, the attribute consolidation module identifies a dominant attribute based on the characteristics of the attributes, the segment identifying module further including an inter-attribute merge module for forming a cumulative, inter-attribute, union of identified and single periods, if any, determined based on a dominant attribute with identified and single periods, if any, determined based on at least one other respective attribute, the union defining a story segment time interval having a start time and an end time, at least some cumulations in forming the union being conditional upon the existence of an intersection, at least partial, between an identified or single period being accumulated and an identified or single period already accumulated in forming the union.

17. The apparatus of claim 1, wherein the attribute comprises a close-caption attribute, the stream includes a text element having representative frames that have the close-caption attribute, the numerical value comprising a count of a number of close-caption marker elements encountered in one or more consecutive representative frames in said identifying of a time period of uniformity.

18. A method for identifying segments of multimedia data of interest, the multimedia data comprising a stream of at least one of audio, video and text elements, the elements having at least one attribute with a numerical value, the attribute being indicative of the content of the element, the method comprising:
identifying a time period of uniformity, if any, during which the numerical value of the attribute of the element of the respective stream meets an attribute uniformity threshold; and
identifying a segment of the multimedia data corresponding to the identified time period of uniformity.

19. The method of claim 18, wherein the segment identifying comprises consolidating pairs of identified time periods of uniformity into a single time period of uniformity that temporally comprises the pair of identified time periods of uniformity.

20. The method of claim 19, wherein the segment identifying further comprises comparing a time span intervening between the pair to a threshold that is based on the attribute and on a characteristic of a predefined thematic collection of data wherein the consolidating of a pair is based on a comparison.

21. The method of claim 19, wherein the segment identifying further comprises comparing between a threshold and a parameter of a time period of uniformity to identify a dominant attribute.

22. The method of claim 21, wherein the segment identifying further includes forming a cumulative, inter-attribute, union of identified and single periods, if any, determined based on a dominant attribute with identified and single periods, if any, determined based on another respective attribute, the union defining a story segment time interval having a start time and an end time.

23. A computer program for identifying segments of multimedia data of interest, the multimedia data comprising a stream of at least one of audio, video and text elements, the elements having at least one attribute with a numerical value, the attribute being indicative of the content of the element, the method comprising:
instruction means for identifying a time period of uniformity, if any, during which the numerical value of the attribute of the element of the respective stream meets an attribute uniformity threshold; and
instruction means for identifying a segment of the multimedia data corresponding to the identified time period of uniformity.
